(19) United States
(12) Patent Application Publication
(10) Pub. No.: US 2008/0284763 A1
(43) Pub. Date: Nov. 20, 2008

(54) Image display apparatus and method, and image generating apparatus and method

(75) Inventors: Jun Someya, Tokyo (JP); Akihiro Nagase, Tokyo (JP); Yoshiteru Suzuki, Tokyo (JP); Akira Okumura, Tokyo (JP)

Correspondence Address: BIRCH STEWART KOLASCH & BIRCH, PO BOX 747, FALLS CHURCH, VA, 22040-0747, US

(73) Assignee: Mitsubishi Electric Corporation

(21) Appl. No.: 12/153,248

(22) Filed: May 15, 2008

(30) Foreign Application Priority Data
May 16, 2007 (JP) 2007-130141

(51) Int. Cl. G06F 3/038

(52) U.S. Cl. 345/204

(57) ABSTRACT

An image signal representing consecutive video frames is resampled, using different sampling phases so that different subsets of pixels are taken from each frame in a consecutive set of frames. The resulting set of resampled frames is combined into a single frame and transferred to an image display unit that divides the single frame into subframes and displays the subframes sequentially with different pixel shifts. Each pixel in each subframe is displayed at its correct spatial and temporal position. Although the resampling process greatly reduces the pixel data transfer rate, the image display unit can reproduce still images without loss of definition and moving images without motion blur.

### BACKGROUND OF THE INVENTION

1. Field of the Invention

The present invention relates to an image display apparatus and method, and an image generating apparatus and method.

2. Description of the Related Art

Display devices that modulate a discrete matrix of picture elements or pixels, such as liquid crystal, plasma, and electroluminescent (EL) or organic light-emitting diode (O-LED) panels and digital micromirror devices (DMDs), are employed in a variety of image display apparatus, including flat-panel television sets, projection television sets, projectors, and computer monitors.

With the advent of high-definition television broadcasting and vastly increased computer processing speeds, the number of pixels displayed in an image is rapidly rising, requiring display devices with denser pixel arrays, but manufacturing these display devices is an exacting process, attended by high costs and reduced manufacturing yields. Manufacturers have accordingly devised display devices that can display a high-definition image with fewer pixels than are present in the input image data by a technique known as pixel shifting or wobbling.

Display devices that display a matrix of pixels are classified as hold-type display devices, examples being active-matrix liquid crystal and EL or O-LED devices, and pulse-width modulation devices, examples being plasma panels and DMDs; both are distinguished from impulsive display devices such as cathode ray tubes (CRTs). A problem with display devices of both the hold type and the pulse-width modulation type is that moving video images are blurred by a discrepancy between display position and the position tracked by the viewer's eye as it attempts to follow the motion.

The problem of motion blur can be mitigated by increasing the frame rate or field rate, using the pixel-shifting or wobbling technique to insert additional pixels. Japanese Patent No. 3847398 to Okamura describes a device that switches between a pixel-shifting mode with an increased field rate for display of fast-moving parts and a non-shifting mode for display of slow-moving or still parts of an interlaced video picture. Japanese Patent No. 3869953 to Endo describes a device that doubles the field rate of an interlaced video signal, employing a wobbling technique to generate additional pixels. Both devices produce smoother motion with reduced blur.

A problem with these devices, however, is that they require pixel data to be read out and transferred at an increased rate. Both the display device and the electronics that control it must therefore operate at an increased speed, which is difficult to accomplish at a low cost.

### SUMMARY OF THE INVENTION

An object of the present invention is to reduce motion blur without increasing the amount of pixel data that must be transferred to the display device.

The invention provides an image display apparatus including an image receiver that receives an image signal from an external source. The image signal is divided into a temporal sequence of frames, each frame representing a plurality of pixels.

A resampler resamples the received image signal by taking a subset of the pixels in each frame to generate a corresponding resampled frame. The resampler operates with at least two different sampling phases, taking different subsets of pixels from each of at least two consecutive frames in the temporal sequence;

An image combiner combines at least two of the resampled frames to form a combined image. An image display unit then divides the combined image into a plurality of interleaved subframes and displays the subframes sequentially with different pixel shifts.

Although the resampling process greatly reduces the rate at which pixel data must be sent to the image display unit, the image display unit displays each pixel in each subframe at its correct spatial and temporal position. The image display unit can therefore reproduce the spatial definition of still images in the received image signal, and can also display moving images that are perceived without motion blur.

### BRIEF DESCRIPTION OF THE DRAWINGS

In the attached drawings:

FIG. 1 is a block diagram of an image display apparatus according to a first embodiment of the invention;

FIG. 2 is an exemplary block diagram of the image display unit in FIG. 1;

FIG. 3A illustrates the arrangement of pixels in the liquid crystal display panel in FIG. 2;

FIGS. 3B and 3C illustrate the subframes stored in the frame memories in FIG. 2;

FIG. 3D illustrates the spatial interleaving of the subframes in FIGS. 3B and 3C;

FIGS. 4A to 4E illustrate interrelationships of the image signal frames and subframes in the first embodiment;

FIGS. 5A and 5B illustrate two frames of image signal B;

FIGS. 6A and 6B illustrate the resampling of the frames in FIGS. 5A and 5B;

FIGS. 7A and 7B illustrate two frames of the resampled image signal C;

FIG. 8 illustrates one frame of the combined image signal D;

FIGS. 9A to 9D illustrate the display of the two subframes into which the frame in FIG. 8 is divided in the image display unit;

FIG. 10 illustrates the spatial interleaving of the subframes in FIGS. 9C and 9D;

FIGS. 11A to 11H illustrate the display of a still image in the first embodiment;

FIGS. 12A to 12H illustrate the display of a moving image in the first embodiment;

FIG. 13 is a block diagram of an image display apparatus according to a second embodiment of the invention;

FIGS. 14A to 14L illustrate the display of a moving image in the second embodiment;

FIGS. 15A to 15L illustrate the display of a still image in the second embodiment;

FIGS. 16A to 16G illustrate interrelationships of the image signal frames and subframes in the second embodiment;

FIG. 17 is a block diagram of an image generating apparatus according to a third embodiment of the invention;

FIGS. 18A and 18B illustrate two frames generated by the image generating apparatus in FIG. 17;

FIGS. 19A to 19C illustrate the division of a frame into subframes and the display of the subframes in the third embodiment;

FIGS. 20A to 20D illustrate the display of an even-numbered frame in the third embodiment; and

FIGS. 21A to 21D illustrate the display of an odd-numbered frame in the third embodiment.

### DETAILED DESCRIPTION OF THE INVENTION

Embodiments of the invention will now be described with reference to the attached drawings, in which like elements are indicated by like reference characters.

### First Embodiment

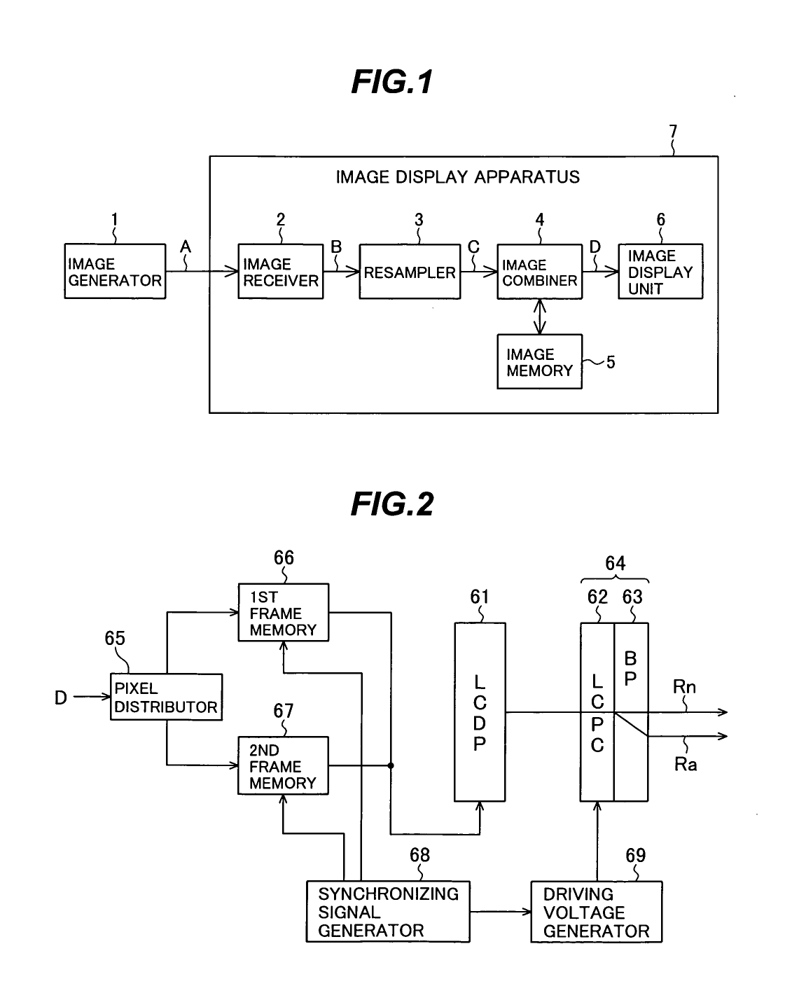

Referring to FIG. 1, in the first embodiment, an image signal A generated by an image generator 1 is received by an image receiver 2 and output from the image receiver 2 as a sampled digital image signal B. A resampler 3 resamples image signal B and outputs a resampled image signal C. An image combiner 4 stores resampled images in an image memory 5, and combines them to generate a combined image signal D. An image display unit 6 displays the combined image signal D as a plurality of subframes. The image receiver 2, resampler 3, image combiner 4, image memory 5, and image display unit 6 constitute an image display apparatus 7 embodying the present invention.

The image signal A may be an electrical signal carried on a cable linking the image generator 1 to the image display apparatus 7, or a wireless signal such as a broadcast television signal or an optical signal. If image signal A is an analog signal, the image receiver 2 samples image signal A and performs analog-to-digital conversion to create image signal B. If image signal A is already a sampled (digital) signal, the image receiver 2 performs conversion processing such as serial-to-parallel conversion, if necessary, to convert the signal data to the format used in subsequent processing in the image display apparatus 7. The image receiver 2 may also convert an image signal expressing luminance and chrominance information to a signal expressing red, green, and blue color information by a well-known matrixing process.

The resampler 3 operates with a constant resampling frequency but with a sampling phase that changes from one frame to the next. The resampling frequency of the resampler 3 is lower than the sampling rate of image signal B, so the resampled image signal C has data for fewer pixels than image signal B. It will be assumed below that the number of pixels per frame in the resampled image signal B is equal to the number of physical pixels in the image display unit 6.

It will also be assumed below that the number of physical pixels in the image display unit 6 is half the number of pixels per frame in image signal A or B. In this case, the resampler 3 operates with two different sampling phases and takes half of the pixels from each frame of image signal B. The pixels taken by the resampler 3 in one frame (say, an odd-numbered frame) are offset by one pixel position from the pixels taken in the next (even-numbered) frame.

The image combiner 4 uses the image memory 5 to combine two or more frames of the resampled image signal C into a single frame, thereby generating the combined image signal D. The image display unit 6 then divides the combined image signal D into subframes and displays the subframes sequentially. It will be assumed below that the image combiner 4 combines two resampled frames into one combined frame, and that the image display unit divides each combined frame into two subframes.

Referring to FIG. 2, the image display unit 6 is, for example, a known device comprising a liquid crystal display panel (LCDP) 61, a liquid crystal polarization controller (LCPC) 62, and a birefringent plate (BP) 63. The liquid crystal polarization controller 62 and birefringent plate 63 constitute a pixel shifter 64, which is disposed in front of the display surface of the liquid crystal display panel 61.

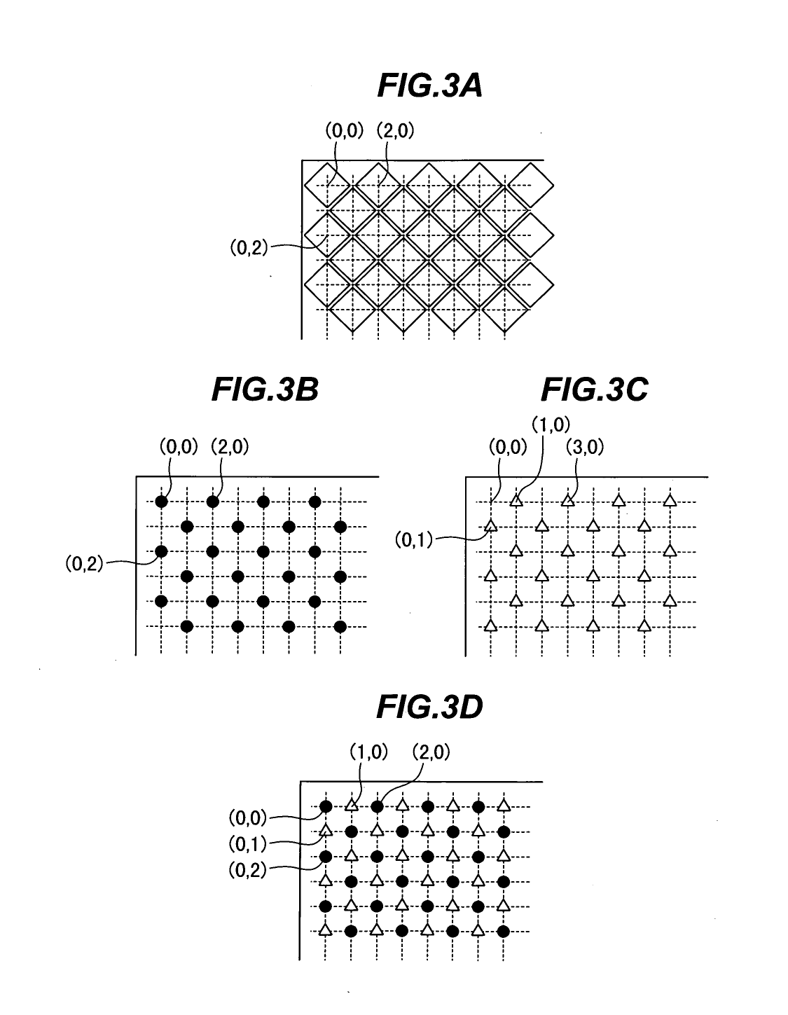

In this embodiment, the liquid crystal display panel 61 comprises physical pixels disposed in a diagonal mosaic array as shown in FIG. 3A. Each vertical column of pixels includes pixels centered in alternate horizontal rows, and each horizontal row of pixels includes pixels centered in alternate vertical columns. Pixel positions can be represented by integer coordinates (x, y).

Referring again to FIG. 2, the image display unit 6 also comprises a pixel distributor 65, a first frame memory 66, a second frame memory 67, a synchronizing signal generator 68, and a driving voltage generator 69. The pixel distributor 65 receives the combined image signal D and sends pixels alternately to the first frame memory 66 and second frame memory 67. The positions of the pixels sent to the first frame memory 66, indicated by black circles in FIG. 3B, duplicate the diagonal mosaic arrangement of the physical pixels of the liquid crystal display panel 61 in FIG. 3A. The positions of the pixels sent to the second frame memory 67 occupy complementary positions, which also have a diagonal mosaic arrangement, as shown in FIG. 3B. The pixel data stored in each of the frame memories 66, 67 constitute a subframe.

After an entire frame of the combined image signal D has been stored in the frame memories 66, 67, the synchronizing signal generator 68 first reads all pixel data from the subframe stored in the first frame memory 66 out to the liquid crystal display panel 61, then reads all pixel data from the subframe stored in the second frame memory 67 out to the liquid crystal display panel 61, while the driving voltage generator 69 selectively applies a predetermined voltage to the liquid crystal polarization controller 62.

To display the subframe stored in the first frame memory 66, the data for each pixel position (x, y) in the subframe are used to drive the pixel at the corresponding position (x, y) in the liquid crystal display panel 61 (FIG. 3A), and a voltage is applied to the liquid crystal polarization controller 62 so that the plane of polarization of the light leaving the surface of the liquid crystal display panel 61 is not rotated in the liquid crystal polarization controller 62. As a result, the light takes the path of the ordinary ray component Rn through the birefringent plate 63, and when the liquid crystal display panel 61 is viewed through the birefringent plate 63, the unaltered image displayed on the liquid crystal display panel 61 is seen. That is, pixels are seen at the positions of the black circles in FIG. 3B.

To display the subframe (FIG. 3C) stored in the second frame memory 67, the data for each pixel position (x, y) in the subframe are used to drive the pixel at the position one row higher (x, y−1) in the liquid crystal display panel 61 (FIG. 3A), and no voltage is applied to the liquid crystal polarization controller 62. The plane of polarization of the light leaving the surface of the liquid crystal display panel 61 is now rotated through ninety degrees in the liquid crystal polarization controller 62, so that the light takes the path of the extraordinary ray component Ra through the birefringent plate 63. When the liquid crystal display panel 61 is viewed through the birefringent plate 63, the image displayed on the liquid crystal display panel 61 appears to be shifted downward by one row (one pixel pitch in the combined image signal D), so that pixels are seen at the positions of the white triangles in FIG. 3C.

To display pixels at top-row positions such as (1, 0) and (3, 0) in FIG. 3C, the liquid crystal display panel 61 may have an extra row of physical pixels (not shown) with coordinates such as (1, −1), (3, −1), and so on.

FIG. 3D shows the pixels displayed in FIG. 3B combined with the pixels displayed in FIG. 3C. As a comparison with FIG. 3A shows, by combining two subframes and shifting the apparent pixel positions in one of the subframes, the image display unit 6 can display twice as many pixels as the number of physical pixels provided by the liquid crystal display panel 61.

By switching between the two subframes at high speed and taking advantage of the temporal integrating effect of human vision, the image display unit 6 in FIG. 2 can increase the spatial resolution of the display by, in effect, spatially interpolating pixels between the pixel centers in the liquid crystal display panel 61.

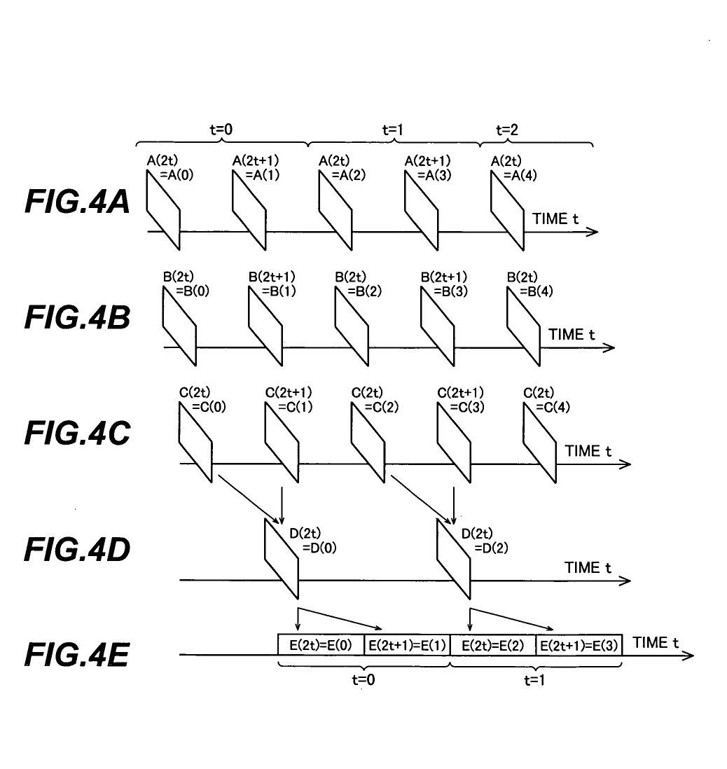

FIGS. 4A to 4E illustrate exemplary relationships between image signals A and B, the resampled image signal C, the combined image signal D, and the image E displayed by the image display unit 6. The numbers and expressions in parentheses following the letters A, B, C, D, and E are frame numbers. The letter t is a discrete time variable that increases in integer steps at the combined frame rate, which is half the input frame rate.

FIG. 4A shows five consecutive frames A(0) to A(4) of the image signal A input to the image receiver 2. Even numbered frames A(2t) (t=0, 1, . . . ) alternate with odd-numbered frames A(2t+1). The image receiver 2 outputs corresponding sampled frames B(2t) and B(2t+1) as shown in FIG. 4B. The resampler 3 outputs corresponding resampled frames C(2t), C(2t+1) with half as many pixels. The resampled frames are shown in FIG. 4C.

The image combiner 4 combines each even-numbered resampled frame C(2t) with the following odd-numbered resampled frame C(2t+1) to form a combined frame D(2t), as shown in FIG. 4D. Resampled frames C(0) and C(1) are combined to form frame D(0); resampled frames C(2) and C(3) are combined to form frame D(2).

The image display unit 6 divides each combined frame D(2t) into two subframes E(2t), E(2t+1) as shown in FIG. 4E, and displays the combined frame for a two-frame (1t) interval by displaying each subframe for one frame interval. Combined frame D(0) is thus divided into subframes E(0) and E(1), which are displayed one after the other. Combined frame D(2) is divided into subframes E(2) and E(3), which are displayed one after the other. Each subframe includes the resampled data for one resampled frame.

The invention is not limited to a liquid crystal display device of the type shown in FIG. 2 with pixels arranged as shown in FIG. 3A. Any type of display device capable of producing a pixel shift may be used. In the following description, however, the device shown in FIG. 2 and the pixel and subframe arrangements shown FIGS. 3A to 3D will be assumed.

The image display unit 6 may be a field-sequential color display that displays red, green, and blue fields successively. In this case, each subframe interval is typically divided into red, green, and blue field intervals. Alternatively, there may be four or more fields. For example, there may be more than three primary colors, including one or more of yellow, cyan and magenta, in addition to red, green and blue, or including one or more of second red, green and blue of different tint, in addition to the first red, green and blue of basic tint.

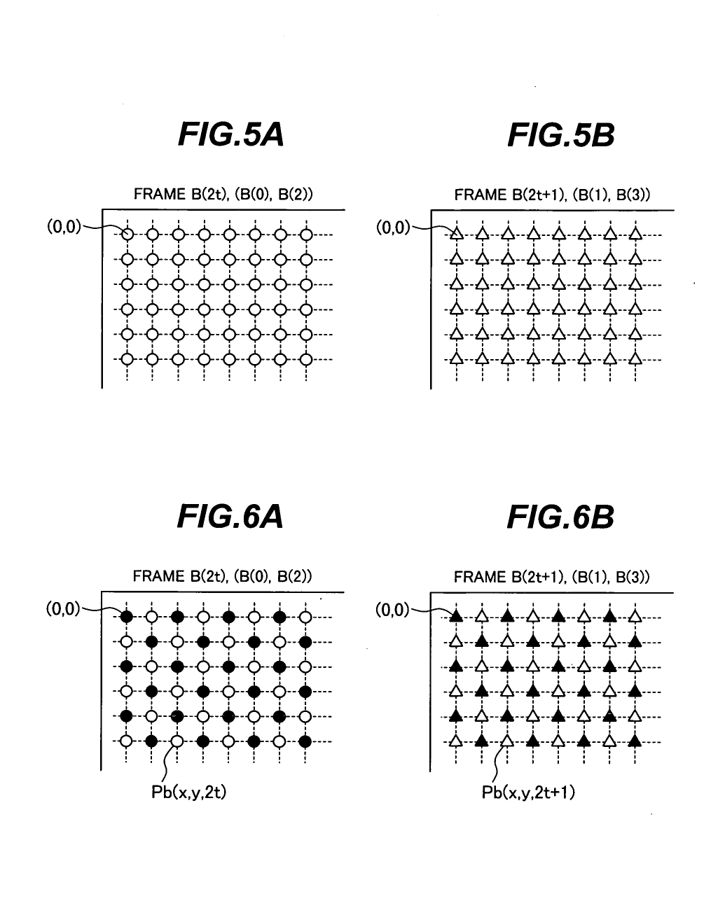

FIGS. 5A and 5B show exemplary pixels in the image signal B output by the image receiver 2. FIG. 5A shows part of an even-numbered frame B(2t), such as B(0) or B(2); FIG. 5B shows part of the succeeding odd-numbered frame B(2t+1), such as B(1) or B(3). Pixel positions are indicated by white circles in FIG. 5A and white triangles in FIG. 5B. The pixels are disposed in a rectangular matrix indicated by the horizontal and vertical dotted lines, at positions indicated by integer coordinates (x, y) as above. The origin (0, 0) is in the top left corner, at the intersection of the topmost row and the leftmost column. The value of x increases by one per column to the right; the value of y increases by one per row downward.

FIGS. 6A and 6B illustrate the two sampling phases of the resampler 3. Even-numbered frames B(2t) are resampled with the phase indicated in FIG. 6A, by taking the pixel data at the positions indicated by black circles and discarding the pixel data at the positions indicated by white circles. Odd-numbered frames B(2t+1) are resampled with the phase indicated in FIG. 6B, by taking the pixel data at the positions indicated by white triangles and discarding the pixel data at the positions indicated by black triangles.

In the following explanation Pb(x, y, 2t) will denote the value of the pixel at position (x, y) in frame B(2t), and Pb(x, y, 2t+1) will denote the value of the pixel at position (x, y) in frame B(2t+1).

In an even-numbered frame B(2t), a pixel is sampled if its coordinates (x, y) are both even or both odd. Such coordinates satisfy the following relation, in which n is an arbitrary positive integer and y %2 indicates the remainder when y is divided by two.

x=2·(n−1)+(y %2)

In an odd-numbered frame B(2t+1), a pixel is sampled if one of its coordinates (x, y) is even and the other is odd. Such coordinates satisfy the following relation.

x=2·(n−1)+(y+1)%2

The resampled pixel values taken from frame B(2t) accordingly have values of the form

Pb(2·(n−1)+(y %2),y,2t)

and the resampled pixel values taken from frame B(2t+1) have values of the form

Pb(2·(n−1)+(y+1)%2,y,2t+1).

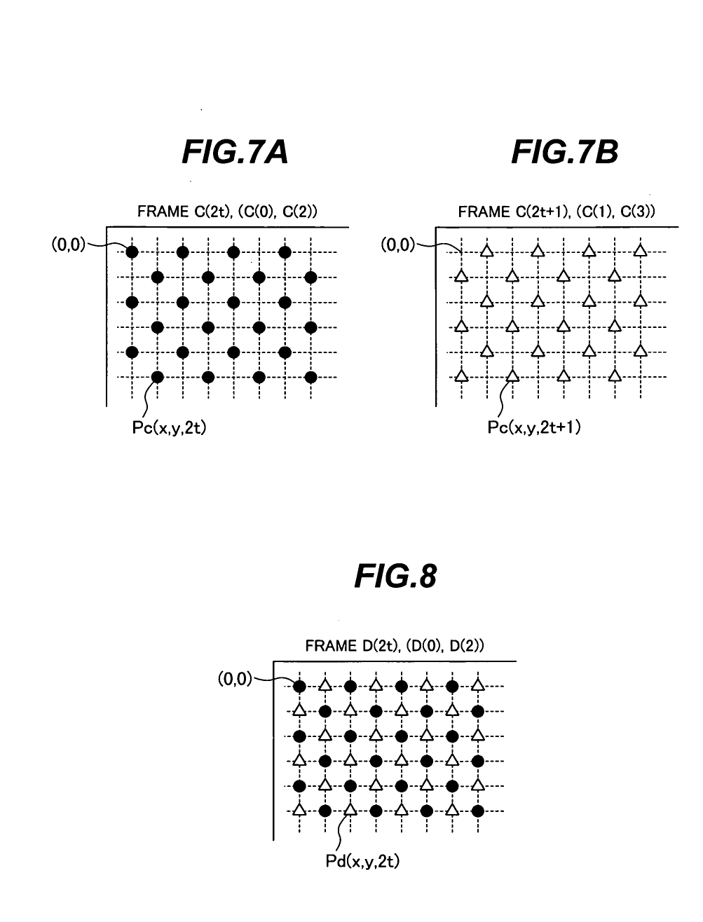

FIGS. 7A and 7B show parts of the resampled frames C(2t) and C(2t+1) output from the resampler 3. The black circles in FIG. 7A represent pixel values Pc(x, y, 2t) identical to the corresponding pixel values Pb(x, y, 2t) in FIG. 6A, and are output to the image combiner 4 as resampled frame C(2t). The white triangles in FIG. 7B represent pixel values Pc(x, y, 2t+1) identical to the corresponding pixel values Pb(x, y, 2t+1) in FIG. 6B, and are output to the image combiner 4 as resampled frame C(2t+1).

The two sampling phases used by the resampler 3 are related in the same way as the two subframes displayed by the image display unit 61, as can be seen by comparing FIGS. 7A and 7B with FIGS. 3B and 3C. The sampling phase represented in FIGS. 6A and 7A corresponds to the zero pixel shift in FIG. 3B. The sampling phase represented in FIGS. 6B and 7B corresponds to the downward pixel shift in FIG. 3C.

The image combiner 4 combines the two resampled frames shown in FIGS. 7A and 7B to generate a combined frame D(2t) with pixel values Pd(x, y, 2t) as shown in FIG. 8. If x and y are both even or both odd, then Pd(x, y, 2t) is identical to Pc(x, y, 2t) and Pb(x, y, 2t). If one of x and y is even and the other is odd, then Pd(x, y, 2t) is identical to Pc(x, y, 2t+1) and Pb(x, y, 2t+1). Accordingly, the image combiner 4 preserves spatial positions while combining two resampled frames into one frame on the time axis.

During this process, the image combiner 4 temporarily stores at least one of the resampled frames in the image memory 5. For example, the image combiner 4 may store the even-numbered resampled frame C(2t) in the image memory 5, then read the stored frame C(2t) as it receives the following odd-numbered resampled frame C(2t+1) and generate the combined frame D(2t) by outputting pixels alternately from frame C(2t) and frame C(2t+1) in a predetermined sequence.

If the image memory 5 has space to store two resampled frames, the image combiner 4 may store both resampled frames C(2t) and C(2t+1), then read out their pixels alternately in a predetermined sequence to generate the combined frame D(2t).

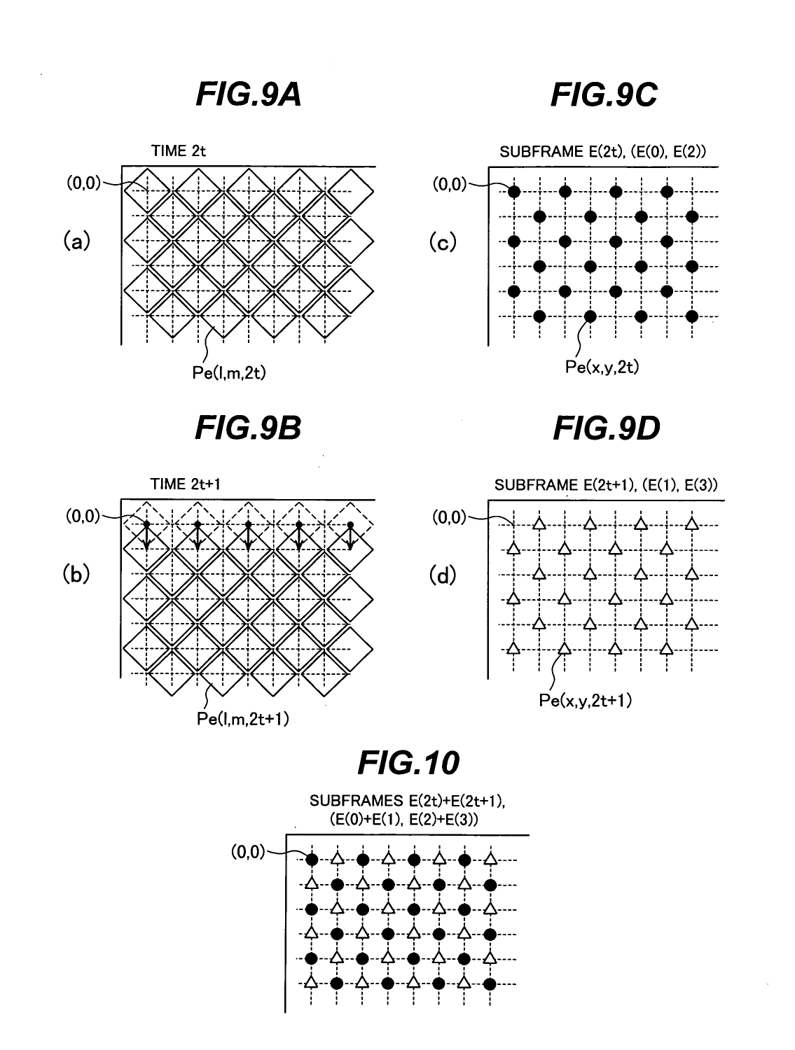

The pixel-shifting operation of the image display unit 6 will be described with reference to FIGS. 9A to 9D. Each combined frame D(2t) is displayed as two subframes synchronized with the pixel-shifting operation of the image display unit 6. FIG. 9A shows the perceived pixel positions Pe(l, m, 2t) during the display of an even-numbered subframe. FIG. 9B shows the perceived pixel positions Pe(l, m, 2t+1) during the display of an odd-numbered subframe. FIG. 9C shows the pixels Pe(x, y, 2t) displayed in the even-numbered subframe. FIG. 9D shows the pixels Pe(x, y, 2t+1) displayed in the odd-numbered subframe.

In FIG. 9A the perceived pixel positions are the same as the actual positions of the physical pixels, both being indicated by squares with sides tilted at angles of forty-five degrees. In FIG. 9B, the perceived pixel positions pixels, indicated by tilted squares as in FIG. 9A, are shifted down by one pixel row from the physical pixel positions, which are indicated in the top row by dotted lines.

The perceived positions of the pixels in FIG. 9A have coordinates that are both even or both odd, such as:
(0, 0), (2, 0), (4, 0), . . . .
(1, 1), (3, 1), (5, 1), . . . .
(0, 2), (2, 2), (4, 2), . . . .

The perceived positions of the pixels in FIG. 9B have mixed even-odd or odd-even coordinates, such as:
(0, 1), (2, 1), (4, 1), . . . .
(1, 2), (3, 2), (5, 2), . . . .
(0, 3), (2, 3), (4, 3), . . . .

The physical pixel that appears at its actual position (x, y) in FIG. 9A appears at position (x, y+1) in FIG. 9B. In an odd subframe, however, the pixel data Pe(x, y, 2t+1), indicated by a white triangle in FIG. 9D, drive the physical pixel at position (x, y−1), which appears to be at position (x, y). In an even subframe, the pixel data Pe(x, y, 2t), indicated by a black circle in FIG. 9C, drive the physical pixel at position (x, y), which likewise appears to be at position (x, y).

The pixel data belonging to the even-numbered subframe E(2t) shown in FIG. 9C in the combined pixel signal D, having the form

Pd(2·(n−1)+(y %2),y,2t)

are accordingly displayed as in FIG. 9A, without a pixel shift. The pixel data belonging to the odd-numbered subframe E(2t+1) shown in FIG. 9D in the combined pixel signal D, having the form

Pd(2·(n−1)+(y+1)%2,y,2t+1)

are displayed with a pixel shift as in FIG. 9B.

FIG. 10 shows both subframes E(2t) and E(2t+1) as if they were displayed at the same time, to illustrate the spatial interleaving of their constituent pixels. The eye first sees the pixels (indicated by black circles) in subframe E(2t), then sees the pixels (indicated by white triangles) in subframe E(2t+1). Each pixel appears at its correct spatial and temporal position, so if there is motion in the image the motion is displayed correctly and can be perceived without blur. If the image is not moving then there is no loss of definition, because pixels are displayed at all positions even though the resampler 3 discards half of the pixel data.

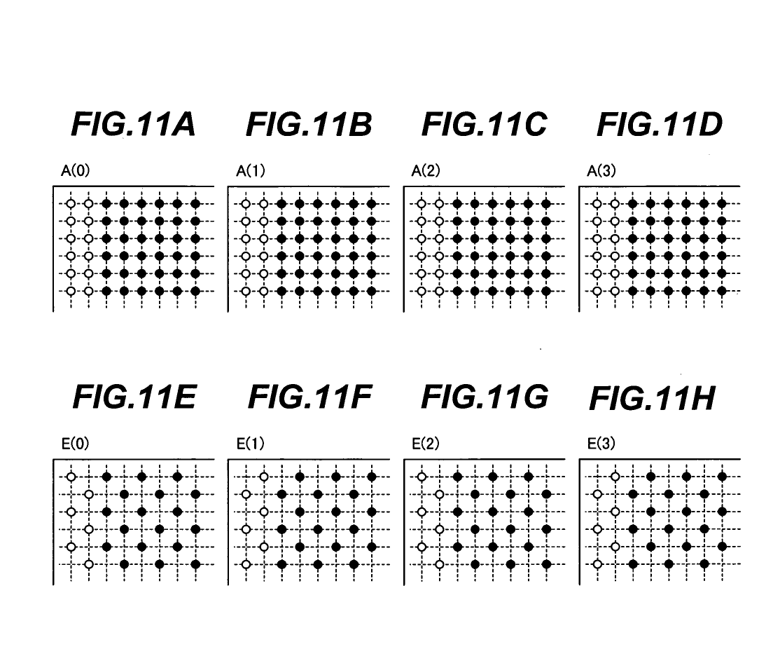

To illustrate this last point, FIGS. 11A to 11H show how the image display unit 6 displays a still image in which the left edge of the screen is light and the area to the right is dark, light pixels being indicated by white circles and dark pixels by black circles. FIGS. 11A to 11D show identical parts of four successive frames A(0), A(1), A(2), A(3) of image signal A. FIGS. 11E to 11H show the corresponding successively displayed subframes E(0), E(1), E(2), E(3). The viewer's eye integrates the even-numbered and odd-numbered subframes and perceives a high-resolution, high-definition display with no missing pixels.

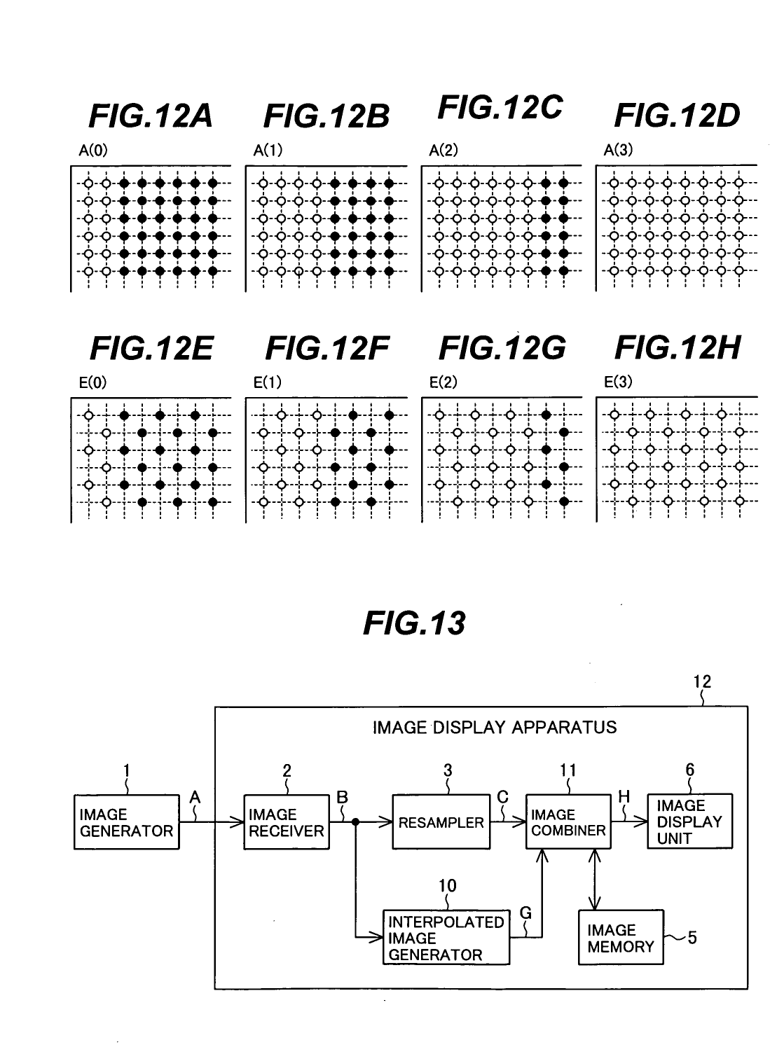

FIGS. 12A to 12H show how the image display unit 6 displays a similar image in which the boundary between the light and dark areas moves to the right. FIGS. 12A to 12D show identical parts of four successive frames A(0), A(1), A(2), A(3) of image signal A, and FIGS. 12E to 12H show the corresponding successively displayed subframes E(0), E(1), E(2), E(3). As the viewer's eye tracks the displayed motion, the boundary between the light and dark areas always appears in the right place and the motion does not seem blurred. Although the eye can no longer integrate the even and odd subframes to perceive the boundary as sharply as in a still image, the spatial acuity of the eye is reduced when following a moving object, so the loss of definition in the displayed image is not noticed. Despite the discarding of half the pixel data in the resampling process, again there is no apparent loss of image quality.

As these examples show, by resampling the image data, using different sampling phases in successive frames, and then combining the resampled data before sending the data to the image display unit 6, the image display apparatus 14 can reduce the frame rate of the data sent to the image display unit 6 with no loss of definition in still images and no noticeable loss of definition in moving images, and without introducing blur into moving images. Moreover, the image display unit 6 can display each frame by a conventional pixel-shifting method, enabling the invention to be practiced without modification of the image display hardware.

In the example above, the frame rate was reduced by half, but greater reductions are also possible. For example, the frame rate can be reduced by a factor of four by having the resampler 3 take only one-fourth of the pixels from each frame of image signal B. The resampler 3 now operates with four different sampling phases, which are applied to four successive frames. Four successive frames of the resampled signal C are spatially combined to form a combined frame D including the same number of pixels as one frame of image signal B, and the combined frame D is supplied to an image display unit 6 that employs a four-way pixel-shifting scheme, displaying the four resampled frames as four subframes with different pixel shifts. The resampling scheme is matched to the pixel-shifting scheme so that each pixel is displayed at its correct spatial and temporal position.

More generally, the invention can be practiced with an image display unit 6 that implements a p-way pixel-shifting scheme, where p is any integer equal to or greater than two. The resampler 3 takes 1/p of the pixels from each frame of image signal B, operating with p different sampling phases, so that each one of p successive frames of image signal B contributes a different subset of pixels to the combined image signal D. The image display unit 6 then displays the pixels as p successive subframes with different pixel shifts, so that each pixel appears at its correct spatial and temporal position. The rate of data transfer to the image display unit 6 is thereby reduced by a factor of p without significant loss of image quality.

### Second Embodiment

Instead of reducing the data transfer rate, the second embodiment interpolates frames to reduce motion blur without raising the data transfer rate.

Referring to FIG. 13, the second embodiment employs an image generator 1, image receiver 2, resampler 3, image memory 5, and image display unit 6 as in the first embodiment, but adds an interpolated image generator 10 and has a different image combiner 11. The image receiver 2, resampler 3, image memory 5, image display unit 6, interpolated image generator 10, and image combiner 11 form an image display apparatus 12.

The image signal A generated by the image generator 1 is input to the image receiver 2 and converted or reformatted to create a digital image signal B, which is supplied to the resampler 3 and the interpolated image generator 10. The resampler 3 samples each frame of image signal B with a predetermined sampling phase to generate the resampled image signal C, which is supplied to the image combiner 11.

The interpolated image generator 10 generates an interpolated image signal G from the input image signal B, each frame of the interpolated image signal G being generated from at least two frames of image signal B. The interpolated image generator 10 has an image memory (not shown) for storing at least one frame of image signal B. The interpolated image signal G is supplied to the image combiner 11.

The image combiner 11 uses the image memory 5 to generate a combined image signal H from the resampled image signal C and interpolated image signal G. The image display unit 6 displays each frame of the combined image signal H as a series of subframes as in the first embodiment.

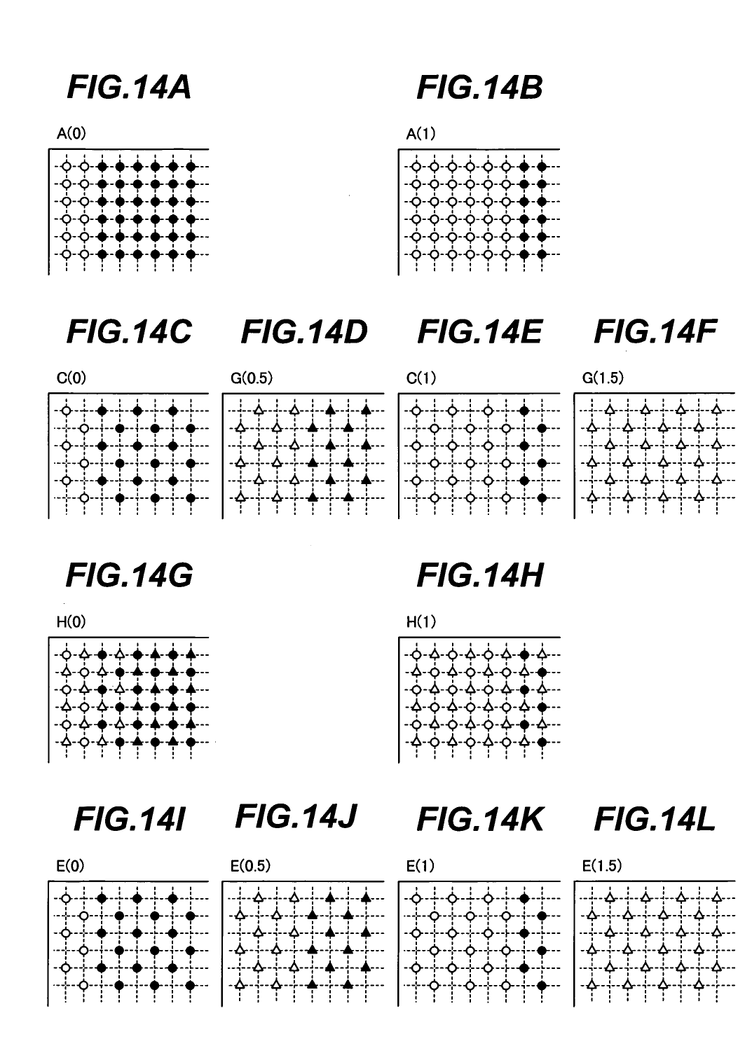

FIGS. 14A to 14L illustrate the operation of the second embodiment for two successive frames A(0) and A(1) of the input image signal A, using white circles and triangles to indicate light pixels and black circles and triangles to indicate dark pixels. In the illustrated parts of these two frames, a light area is disposed to the left of a dark area, and the boundary between the light and dark areas moves four pixels to the right between the two frames. For illustrative purposes, it will be assumed that the resampler 3 takes half the pixels in each frame of image signal B, and the interpolated image generator 10 interpolates one frame between each two successive frames of image signal B.

Differing from the first embodiment, the resampler 3 operates on every frame with the same sampling phase. In taking half the pixels from each frame, the resampler 3 generates resampled frame C(0) in FIG. 14C from the part of image signal B corresponding to frame A(0) in FIG. 14A and resampled frame C(1) in FIG. 14E from the part of image signal B corresponding to frame A(1) in FIG. 14B. Using the same notation as in the first embodiment, the sampled pixels have values of the form:

Pb(2·(n−1)+(y %2),y,2t)

and

Pb(2·(n−1)+(y %2),y,2t+1)

The interpolated image generator 10 interpolates the frame G(0.5) in FIG. 14D between frames A(0) and A(1), generating pixel values at the pixel positions not sampled by the resampler 3. The interpolated image generator 10 may employ any known temporal interpolation scheme. In the illustrated scheme, the interpolated image generator 10 detects motion in image signal B, generates motion vectors, uses the motion vectors to extract appropriate pixels from the parts of image signal B corresponding to frames A(0) and A(1), and uses the extracted pixel values to generate interpolated pixel values. Thus the interpolated image generator 10 detects the four-pixel rightward motion of the light-dark boundary between FIGS. 14A and 14B and interpolates values in frame G(0.5) so that the light-dark boundary is shifted two pixels to the right from its position in FIG. 14A. If the same motion continues, the interpolated image generator 10 also generates an interpolated frame G(1.5), shown in FIG. 14F, in which the light-dark boundary is two pixels to the right of its position in FIG. 14B.

Using the same notation as in the first embodiment, the interpolated image generator 10 generates pixel values of the form:

Pb(2·(n−1)+(y+1)%2,y,2t+0.5)

and

Pb(2·(n−1)+(y+1)%2,y,2t+1.5)

The image combiner 11 spatially combines frame C(0) received from the resampler 3 with frame G(0.5) received from the interpolated image generator 10 to generate the combined frame H(0) shown in FIG. 14G, and spatially combines frame C(1) received from the resampler 3 with frame G(1.5) received from the interpolated image generator 10 to generate the combined frame H(1) shown in FIG. 14H. The frame rate of the combined image signal H is the same as the frame rate of image signals A and B.

The image display unit 6 divides each frame in the combined image signal H into a first subframe including pixel values output by the resampler 3 and a second subframe including pixel values output by the interpolated image generator 10, and displays these subframes with a pixel shift as described in the first embodiment. In the present example the image display unit 6 displays successive subframes E(0), E(0.5), E(1), E(1.5) corresponding to frames C(0), G(0.5), C(1), G(1.5) as shown in FIGS. 14I to 14L.

Although the light-dark boundaries are blurred in the combined frames H(0) and H(1) in FIGS. 14G and 14H, the blur disappears when the combined frames are divided into subframes in the image display unit 6 as in FIGS. 14I to 14L. Moreover, the viewer perceives smoother motion in the image displayed by the image display unit 6, since the light-dark boundary moves in steps of two pixels instead of four. The enhanced smoothness is achieved with no increase in the amount of data transferred to the image display unit 6, since the frame rate of the combined image signal H is the same as the frame rate of image signals A and B.

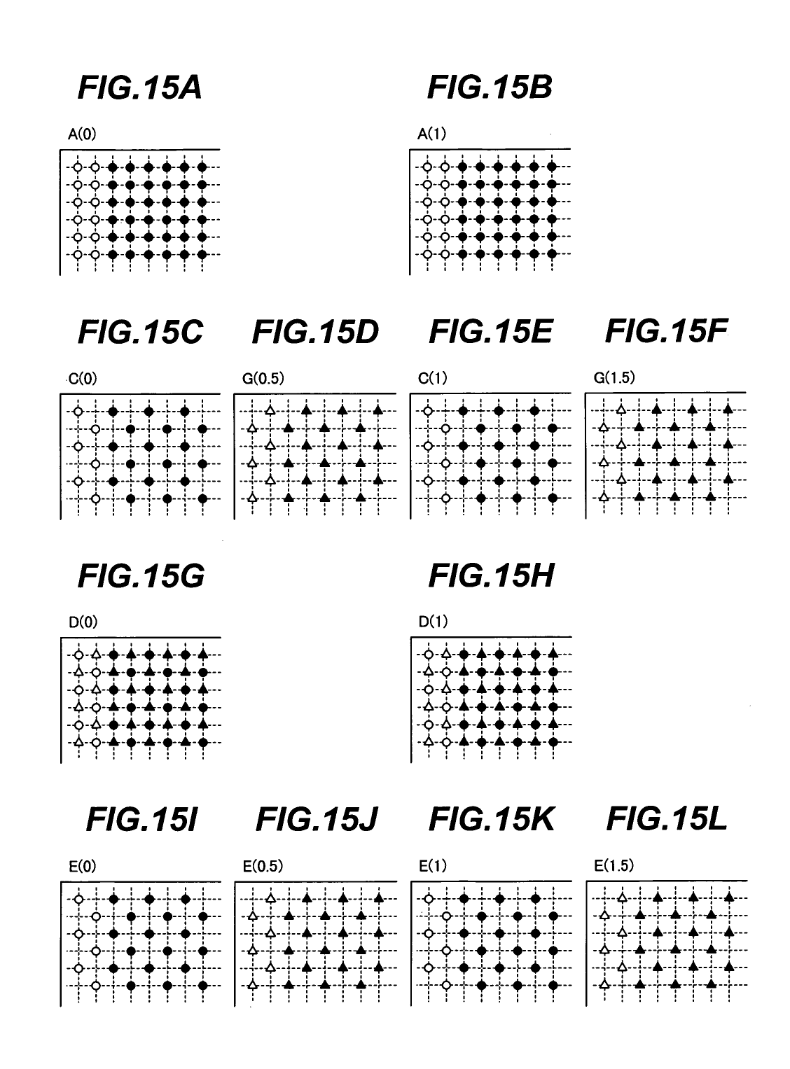

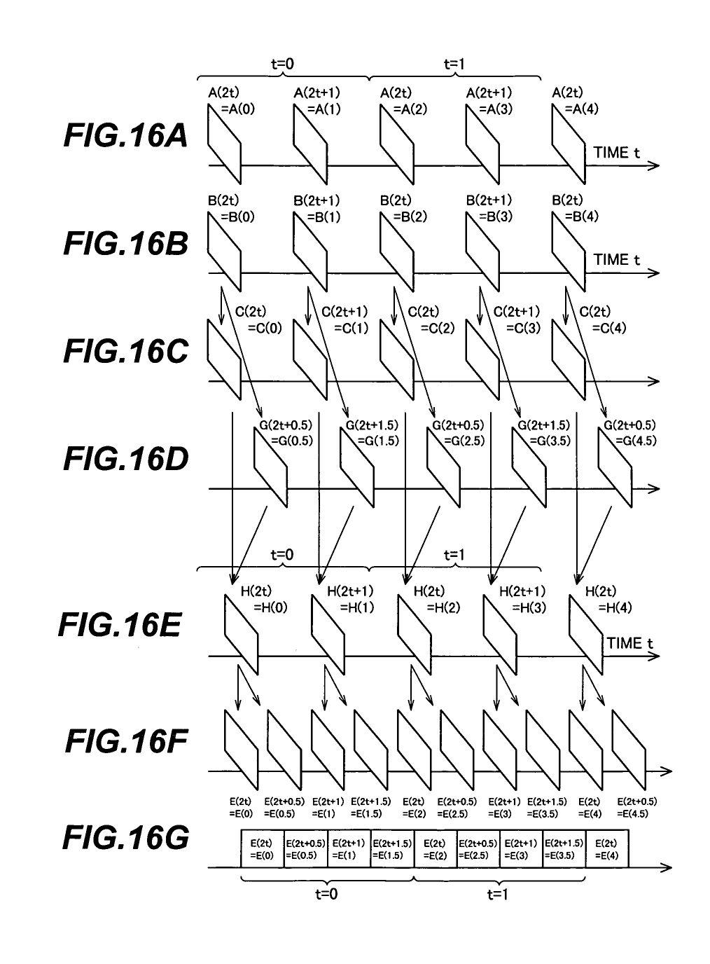

FIGS. 15A to 15L illustrate the display of a still image in the second embodiment. The input frames A(0), A(1) in FIGS. 15A and 15B are both identical to frame A(0) in FIG. 14A. The resampled frames C(0), C(1) in FIGS. 15C and 15D are both identical to frame C(0) in FIG. 14C. The interpolated frames G(0.5), G(1.5) in FIGS. 15D and 15F include the pixels from the still image in frames A(0) and A(1) that were not sampled by the resampler 3, so the light-dark boundary is in the same position as in the resampled frames C(0) and C(1). The combined frames H(0) and H(1) in FIGS. 15G and 15H are both identical to the input frames A(0), A(1). When the combined frames are divided into subframes E(0), E(0.5), E(1), and E(1.5) as in FIGS. 15I to 15L and displayed by the image display unit 6, the viewer's eye integrates the integer-numbered subframes with the half-integer-numbered subframes and perceives a full-definition image, as if the image display unit 6 had displayed all the pixels in input frame A(0) or A(1) simultaneously.

FIGS. 16A to 16G illustrate how frames are interpolated, combined, and divided into subframes in the second embodiment. The letter t is a discrete time variable that increases in integer steps at half the frame rate.

The image receiver 2 receives the five consecutive frames A(0) to A(4) of the image signal A shown in FIG. 16A and outputs the corresponding frames B(0) to B(4) shown in FIG. 16B. The resampler 3 outputs corresponding resampled frames C(0) to C(4) with half as many pixels, as shown in FIG. 16C. The interpolated image generator 10 interpolates frames between the frames output by the image receiver 2 in FIG. 16B. The frame interpolated between frames B(2t) and B(2t+1) is denoted G(2t+0.5), as in FIG. 16D. The frame interpolated after frame-B(2t+1) is denoted G(2t+1.5). The interpolated frames G(0.5), G(1.5), . . . , G(4.5) each have the same number of pixels as the resampled frames in FIG. 16C.

The image combiner 4 combines each resampled frame with the following half-integer-numbered interpolated frame to form a combined frame, which is numbered with the same integer as the resampled frame. Thus frames C(0) and G(0.5) are combined to form frame H(0), frames C(1) and G(1.5) are combined to form frame H(1), and so on as indicated in FIG. 16E.

The image display unit 6 divides each combined frame into two subframes: an integer-numbered subframe including the pixel data from the resampled frame, and a half-integer-numbered subframe including the pixel data from the interpolated frame. Thus as indicated in FIG. 16F, frame H(0) is divided into subframe E(0), which includes the data from resampled frame C(0), and subframe E(0.5), which includes the data from interpolated frame G(0.5). The other combined frames are divided into subframes similarly. The subframes are displayed successively in ascending order of their integer and half-integer numbers as indicated in FIG. 16G, and are thus displayed at twice the original frame rate in FIG. 16A.

By interpolating frames that are spatially and temporarily interleaved with the resampled frames, the second embodiment is able to display moving images with smoother motion, without degrading the perceived definition of either moving or still images. The second embodiment thus provides an effective solution to the problem of motion blur that occurs in hold-type displays, and also to the problem of judder, a jerky type of motion that occurs as a result of frame rate conversion.

In a variation of the second embodiment, each half-integer-numbered interpolated frame is combined with the following resampled frame instead of the preceding resampled frame. For example, interpolated frame G(0.5) is combined with resampled frame C(1) to form combined frame H(1). The same effect is produced.

### Third Embodiment

The third embodiment of the invention is an image generating apparatus that generates an image signal that can be displayed by a pixel-shifting image display device to produce high-definition blur-free images without requiring a high data transfer rate.

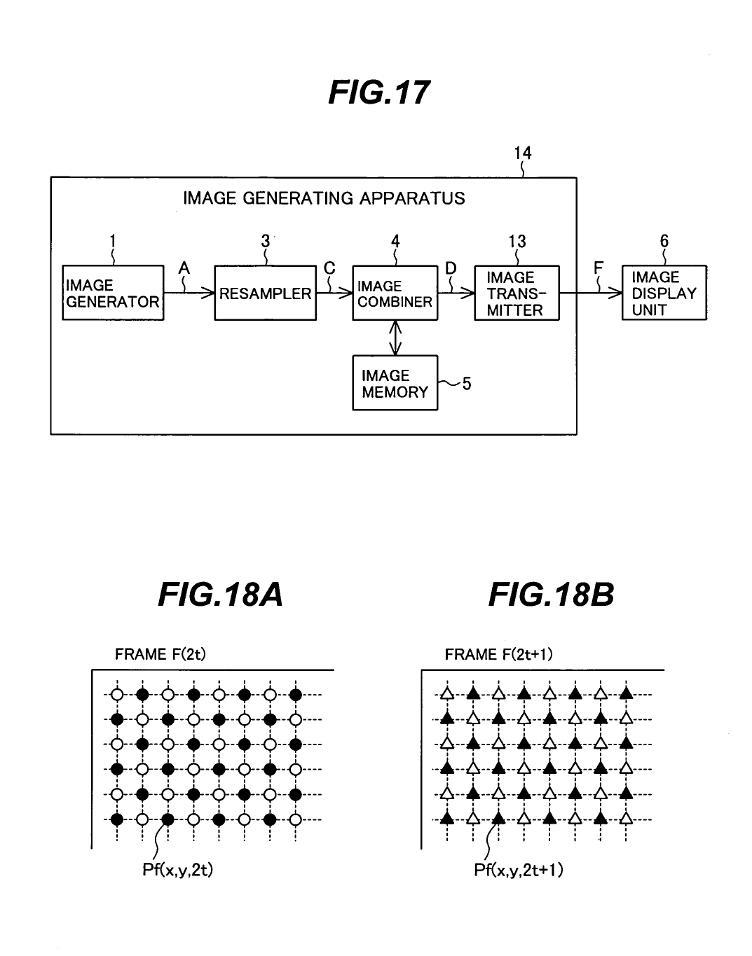

Referring to FIG. 17, in the third embodiment, an image generator 1 outputs a sampled digital image signal A directly to a resampler 3, which resamples the image signal and outputs a resampled image signal C to an image combiner 4. Using an image memory 5, the image combiner 4 outputs a combined image signal D to an image transmitter 13, which sends the combined image as an output image signal F to an image display unit 6. The image generator 1, resampler 3, image combiner 4, image memory 5, and image transmitter 13 constitute the image generating apparatus 14. The image signal F supplied from the image nerating apparatus 14 to the image display unit 6 may be an electrical signal carried on a cable, or a wireless signal, or an optical signal.

The resampler 3, image combiner 4, image memory 5, and image display unit 6 operate substantially as in the first embodiment. The frame rate of the combined image signal D output by the image combiner 4 is 1/p of the frame rate of the image signal A output by the image generator 1. The image display unit 6 divides each received frame into p subframes. In the following description the parameter p is equal to two.

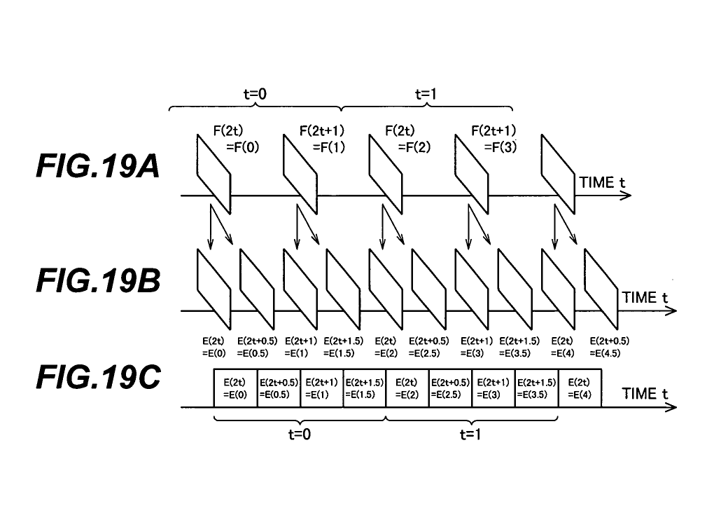

To the image display unit 6, the image generating apparatus 14 is simply a device that outputs successive frames, which may be given successive integer numbers. FIG. 18A shows an even-numbered frame F(2t); FIG. 18B shows an odd-numbered frame F(2t+0.1). FIG. 19A shows a series of output frames F(0), F(1), . . . .

As shown in FIG. 19B, the image display unit 6 divides an even-numbered frame F(2t) into a pair of subframes E(2t), E(2t+0.5) and divides an odd-numbered frame F(2t+1) into a pair of subframes E(2t+1), E(2t+1.5). The subframes are displayed in ascending order as indicated in FIG. 19C. Even-numbered and odd-numbered frames are divided into subframes and displayed in the same way.

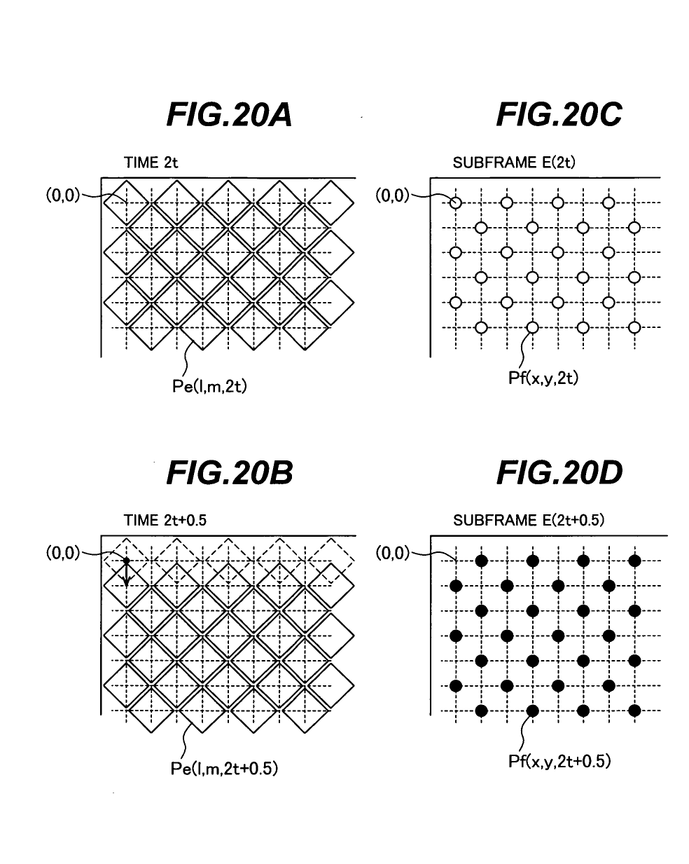

FIGS. 20A to 20D illustrate the display of the even-numbered frame F(2t) in FIG. 18A. The pixels Pf(x, y, 2t) indicated by white circles in FIG. 18A form subframe E(2t). This subframe is displayed without a pixel shift at time 2t at the pixel positions Pe(l, m, 2t) shown in FIG. 20A. The pixels Pf(x, y, 2t) indicated by black circles in FIG. 18A form subframe E(2t+0.5), which is displayed with a pixel shift at time 2t+0.5 at the pixel positions Pe(l, m, 2t+0.5) shown in FIG. 20B. The viewer sees the pixels indicated by white circles at the positions Pf(x, y, 2t) in FIG. 20C, and then the pixels indicated by black circles at the shifted positions Pf(x, y, 2t+0.5) in FIG. 20D. Each pixel is displayed at its correct spatial and temporal position.

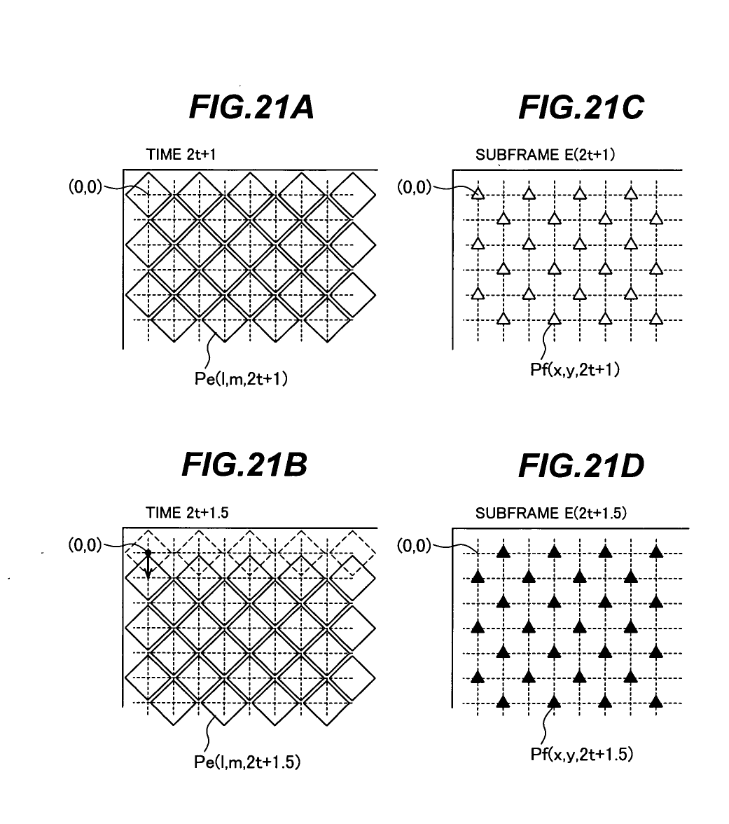

FIGS. 21A to 21D illustrate the display of the odd-numbered frame F(2t+1) in FIG. 18B. The pixels Pf(x, y, 2t) indicated by white triangles in FIG. 18B form subframe E(2t+1). This subframe is displayed without a pixel shift at time 2t at the pixel positions Pe(l, m, 2t+1) shown in FIG. 20A. The pixels Pf(x, y, 2t+1) indicated by black triangles in FIG. 18B form subframe E(2t+1.5), which is displayed with a pixel shift at time 2t+0.5 at the pixel positions Pe(l, m, 2t+1.5) shown in FIG. 21B. The viewer sees the pixels indicated by white triangles at the positions Pf(x, y, 2t+1) in FIG. 21C, and then the pixels indicated by black triangles at the shifted positions Pf(x, y, 2t+1.5) in FIG. 21D. Each pixel is displayed at its correct spatial and temporal position.

In the image generating apparatus 14, the frame rate of the image signal A output by image generator 1 matches the subframe rate of the image display unit 6. Since the image combiner 4 combines two resampled frames into one, the frame rate of the combined image signal D and the output image signal F matches the frame rate of the image display unit 6.

The image signal A generated by the image generator 1 is preferably a high-definition signal with a comparatively high frame rate, capable of displaying sharp moving images without motion blur. The image generating apparatus 14 takes advantage of the pixel-shifting operation of the image display unit 6 to convert image signal A to an image signal F with the same high definition but a lower frame rate. Although the pixels in a given frame of the output image signal F do not all represent the image at the same instant in time, when image signal F is divided into subframes and displayed by the image display unit 6, all pixels are displayed in their correct temporal and spatial positions. The displayed image therefore produces substantially the same visual effect as would have been produced by displaying image signal A on a more expensive image display device with more physical pixels and a higher data transfer rate; the viewer sees a sharp picture without motion blur.

In a variation of the third embodiment, the image generator 1 is configured to output pixel data only for the pixels that will be sampled by the resampler 3, and the resampler 3 is eliminated. That is, the image generator 1 generates p successive frames with complementary interleaved pixel arrangements, and the image combiner 4 combines the p frames to create one frame of the combined image signal.

Although a progressive scanning scheme is implicitly assumed for the image signals in the embodiments above, the invention can also be practiced with interlaced scanning.

Those skilled in the art will recognize that further variations are possible within the scope of the invention, which is defined in the appended claims.

What is claimed is:

1. An image display apparatus comprising:
an image receiver for receiving an image signal from an external source, the image signal being divided into temporally consecutive frames, each frame representing a plurality of pixels;
a resampler for resampling the received image signal by taking a subset of the pixels in each frame to generate a corresponding resampled frame, the resampler operating with at least two different sampling phases and taking different subsets of pixels from each of at least two consecutive frames of the image signal;
an image combiner for combining at least two of the resampled frames to form a combined image; and
an image display unit for dividing the combined image into a plurality of interleaved subframes and displaying the subframes sequentially with different pixel shifts.

2. The image display apparatus of claim 1, wherein each of the sampling phases used by the resampler corresponds to one of the pixel shifts used by the image display unit.

3. The image display apparatus of claim 1, wherein the number of different sampling phases used by the resampler is equal to the number of subframes in said plurality of interleaved subframes.

4. The image display apparatus of claim 1, wherein the number of resampled frames combined by the image combiner to form the combined image is equal to the number of subframes in said plurality of interleaved subframes.

5. An image display apparatus comprising:
an image receiver for receiving an image signal from an external source, the image signal being divided into temporally consecutive frames, each frame representing a plurality of pixels;
a resampler for resampling the received image signal by taking a subset of the pixels in each frame to generate a corresponding resampled frame;
an interpolated image generator for interpolating at least one interpolated frame between each consecutive pair of frames in the image signal;
an image combiner for combining at least one of the resampled frames with at least one of the interpolated frames to form a combined image, the combined resampled frames and interpolated frames forming a temporally consecutive sequence; and
an image display unit for dividing the combined image into a plurality of interleaved subframes and displaying the subframes sequentially with different pixel shifts.

6. The image display apparatus of claim 5, wherein the temporally consecutive sequence corresponds to a sequence in which the image display unit displays the subframes in said plurality of interleaved subframes.

7. The image display apparatus of claim 5, wherein the total number of resampled frames and interpolated frames combined to form the combined image is equal to the number of subframes in said plurality of interleaved subframes.

8. The image display apparatus of claim 5, wherein the interpolated frames have pixels at different positions from the resampled frames.

9. An image display method comprising:
receiving an image signal from an external source, the image signal being divided into temporally consecutive frames, each frame representing a plurality of pixels;
resampling the received image signal by taking a subset of the pixels in each frame to generate a corresponding resampled frame, using at least two different sampling phases and taking different subsets of pixels from each of at least two consecutive frames of the image signal;
combining at least two of the resampled frames to form a combined image;
dividing the combined image into a plurality of interleaved subframes; and
displaying the subframes sequentially with different pixel shifts.

10. An image display method comprising:
receiving an image signal from an external source, the image signal being divided into temporally consecutive frames, each frame representing a plurality of pixels;
resampling the received image signal by taking a subset of the pixels in each frame to generate a corresponding resampled frame;
interpolating at least one interpolated frame between each consecutive pair of frames in the image signal;
combining at least one of the resampled frames with at least one of the interpolated frames to form a combined image, the combined resampled frames and interpolated frames forming a temporally consecutive sequence;
dividing the combined image into a plurality of interleaved subframes; and
displaying the subframes sequentially with different pixel shifts.

11. An image generating apparatus comprising:
an image generator for generating a temporally consecutive sequence of frames, each frame representing an image with a plurality of pixels;
a resampler for taking a subset of the pixels in each frame to generate a corresponding resampled frame, the resampler operating with at least two different sampling phases and taking different subsets of pixels from each of at least two consecutive frames in the temporally consecutive sequence;
an image combiner for combining at least two of the resampled frames to form a combined image representing at least two frames in the temporally consecutive sequence; and
an image transmitter for transmitting the combined image.

12. An image generating method comprising:
generating a temporally consecutive sequence of frames, each frame representing an image with a plurality of pixels;
taking a subset of the pixels in each frame to generate a corresponding resampled frame, using at least two different sampling phases and taking different subsets of pixels from each of at least two consecutive frames in the temporally consecutive sequence;
combining at least two of the resampled frames to form a combined image representing at least two frames in the temporally consecutive sequence; and
transmitting the combined image.
